(19) United States
(12) Patent Application Publication
(10) Pub. No.: US 2010/0270825 A1
(43) Pub. Date: Oct. 28, 2010

(54) Corner Tarp Connector System

(76) Inventors: Ilir Beshiri, Windsor (CA); Brian Petelka, Carlisle (CA)

Correspondence Address: Ilir Beshiri, 574 Cora Greenwood Dr., Windsor, ON, N8P 1K1, CA

(21) Appl. No.: 12/770,720

(22) Filed: Apr. 30, 2010

(30) Foreign Application Priority Data
Apr. 21, 2009 (CA) 2665408

(51) Int. Cl. B60P 7/04

(52) U.S. Cl. 296/100.16

(57) ABSTRACT

The invention consists of a system for connecting tarps to a vehicle, but not limited to, comprising: a) frames for supporting tarps, the frame comprised of: i) one or more tarp connectors, each of the tarp connectors having a pair of channels for accepting a support pole and ii) one or more corner connector systems adapted to receive an end of one of the tarp connectors; b) a plurality of tarps, each tarp secured to the tarp connectors by wrapping the tarp around the support pole and inserting the support pole into the channel of the tarp connector, wherein the frames are combined with the tarps to create an enclosed cargo area for the vehicle.

### FIELD OF THE INVENTION

The present invention relates to the field of cover tarp systems, in particular, but not exclusively, for covering vehicle beds. In particular, it relates to corner connectors used for securing the tarps in the corners.

### BACKGROUND OF THE INVENTION

Shipping of goods, both regionally and internationally, is conducted by several means, including rail, ship and, very often, truck. While container trucks or truck-trailer combinations are used, particularly in conjunction with rail or ship container shipping, in many places and situations, a standard flatbed truck is used. In order to protect the shipped goods from exposure to the elements, they are typically covered with tarps. In order to ensure optimal shipping conditions, a system of securing the tarps to the flatbed is required. Generally, a series of frames are attached to the flatbed and then one or more tarps are attached to the frames to create an enclosed, roughly cuboid cargo roughly area. The most common currently known means of securing the tarps to the frames involves flaps on the tarp which overlap the frame, generally using Velcro™ or similar means. The tarp is required to be modified to include the flaps, and after repeated use the flaps do not secure as well, suggesting a need for an improved method of securing the tarps.

In the cover systems used, the corner tarp connector either does not exist by having one continues connector element or it causes complications in securing the tarps to the frames. In both cases the complexity of securing the tarp to the frames is present, particularly when one continuous tarp connector element is used.

U.S. Pat. No. 4,902,064 issued to Tuerk et al. discloses a Conestoga-style tarp system using frames which are attached to guide rails attached to the sides of the vehicle flatbed. The rearmost frame is designed to be tilted or leaned to provide tension to the tarp and to secure the frame. The tarp is a single tarp which is extended over the frames and supported by the tension created by the positioning of the rearmost frame. The Tuerk tarp system does not disclose any use of multiple tarps, nor any means of securing the tarp to the individual frames or using the corner in the connection.

U.S. Pat. No. 5,538,313 issued to Henning discloses a tarp system for a flatbed trailer including three sets of frame members (front, intermediate, rear) for supporting the tarp. The frame members are slidably mounted to guide rails running along the sides of the flatbed, thus enabling the frame members to be moved to different locations on the flatbed and for the entire assembly to be compressed or expanded as required to load and unload the vehicle. Henning is a modified version of the Tuerk system and is similarly design around a single tarp supported by tension created by frame positioning. There is no disclosure of any system using multiple tarps or any means of securing the tarps to individual frames or connecting the tarps by tarp connectors in the corners where the member of the structure meets.

U.S. Pat. No. 5,080,423 issued to Merlot et al. discloses a segmented tarp cover system. The Merlot tarp is designed as a series of segmented tarp pieces which are extended to cover the top of a cargo container, such as a rail car of truck trailer. The Merlot system is designed solely for a top covering and does not disclose any means or method of covering the sides and ends of a cargo container or surface, neither is disclosed the way how you connect the tarp connectors in the corners where the members meets.

U.S. Pat. No. 7,344,178 issued to Lowry et al. discloses a cover system for a trailer of a freight transport vehicle having a cargo space, the cover system having a pair of track brackets, tracks, generally U-shaped frame portions mounted to the trucks so that there is displacement of the frame portions as each member of the pair of trucks is displaced along the length of the members of the track and a flexible canopy supported by the frame members for covering or uncovering the cargo space. Further more in this patent is disclosed a corner bracket system compound from a corner bracket with a central body and a pair of tongues extending each side and pair of corner plates marching the central body. The tarp connector being a continuous component forming the frame not only takes away payload space, by having the poles extruded outside ,but also makes it difficult to assemble the tarpaulin at the formed corners of the frames.

U.S. Pat. No. 5,924,759 and C.A. Patent No. 2,197,750 issued to DeMonte et al. discloses a retractable enclosure system for covering a bed of a truck, trailer or the like is provided, which includes a number of generally U-shaped frames for supporting a flexible cover, and elongate rails provided along each side of the bed. The rails each have a flat uppermost surface along which the frames move to extend or collapse the flexible cover. The frames span the bed having two vertical legs connected at an upper end by a central bight, and a guide assembly provided at the lower end of each leg. The guide assembly includes one or more supporting wheels which rotatably engage the upper surface of the rails and a guide wheel which rotatably engages the side of the bed and/or a portion of the rail to limit lateral movement of the supporting wheels. The DeMonte tarp system does not disclose any use of multiple tarps, nor any means of securing the tarp to the individual frames or using any kind of corner in the connection of the frames.

All the disclosed cover systems either do not enable the tarps to be secured direct into the tarp connectors or by having the poles of the extrusion from outside of the main profiles , they increases the width of the flatbed, risking violation of regulations or takes away available cargo space from the flatbed, making it less efficient. Nor is disclosed any means of how to securing the tarp to the individual frames in the corner the connection.

Even when the installation of the guide rails and tarp connectors is monitored to ensure compliance with width regulations; it is still common to have the tarp attachment means (flaps, buckles, etc.) on the exterior. These means may then extend beyond the legal width permitted for the cargo bed, and the driver/operator may not even be aware of the violation. Thus, there is a need for a corner tarp connector system without external tarp attachment means to ensure compliance with legal restrictions on vehicle width.

The above patents are illustrative of the limitations in the known art. In addition to the above-noted limitations, the corners of the frame protrude into the interior of the cargo area, reducing the amount of available space and imposing restrictions on loading. In the systems disclosed while the tarp is being secured to the frames it is very complicated to assemble the tarp assembly to the corner connections. There is a need in the tarp and trucking industry to address these limitations and needs.

It is an object of this invention to partially or completely fulfill one or more of the above-mentioned needs.

### SUMMARY OF THE INVENTION

The invention consists of a corner tarp connector system for connecting tarps to a vehicle but not limited to, comprising: a) a corner comprising: i) a main body, representing the strength of the corner structure, with opposite directed faces one or more extended step portions part of the main body. These extended step portions are made such a way to accept the tarp connectors by sliding them through from inside while being assembled iii) each extended step portion has one or more holes to accept the fasteners that connect the corner system together with tarp connectors an extended shape outward and around the main body producing closure for the tarp connectors, where this shape has a channel, allowing the tube with wrapped around tarp to slide through. b) a corner cap being able to assembled after the tarp, providing ease of mounting , comprising i) a main body with two outward step extensions an outward and around the main body shape, having a channel to accept the tarp, adapted for the corner and the tarp connectors providing a full closure c) one or more compressible gaskets adapted to fit within the profile of the tarp connectors and corner system as a sealing element d) one or more side compressible gaskets adapted to seal the corner and corner cap e) Frames for supporting tarps, the frame comprised of: i) one or more tarp connectors, each of the tarp connectors having a pair of channels for accepting a support pole f) a plurality of tarps, each tarp secured to the tarp connectors by wrapping the tarp around the support pole and inserting the support pole into the channel of the tarp connector, wherein the frames are combined with the tarps to create an enclosed cargo area .

The invention further includes a method of connecting tarps to a vehicle, comprising: a) attaching frames to a vehicle, the frames comprised of: i) one or more tarp connectors, each of the tarp connectors having a pair of channels for accepting a support pole and one or more corner connector systems adapted to receive an end of one of the tarp connectors; b) wrapping the tarps around the support poles, and c) inserting the support poles into the tarp connectors to create a cargo area for the vehicle enclosed by the tarps.

Preferably, the corner connector systems are detachably removable from the tarp connectors.

Other and further advantages and features of the invention will be apparent to those skilled in the art from the following detailed description thereof, taken in conjunction with the accompanying drawings

### BRIEF DESCRIPTION OF THE DRAWINGS

The invention will now be described in more detail, by way of example only, with reference to the accompanying drawings, in which like numbers refer to like elements, wherein:

FIG. 1 is a front view of the corner tarp connector system with connected tarps according to the present invention;

FIG. 2 is a view of a section of corner tarp connector system on fastener location of FIG. 1;

FIG. 3 is a perspective view of the corner connector system ;

FIG. 4 is a perspective view of a complete frame including tarps assembled using tarp connectors and corner tarp connector systems of the present invention;

FIG. 5 is a perspective view of a complete frame using tarp connectors and corner tarp connector systems of the present invention;

FIG. 6 is a back view of a complete frame assembled using tarp connectors and corner tarp connector systems of FIG. 5;

FIG. 7 is a perspective view of the corner cap;

FIG. 8 is a side view of the corner cap;

FIG. 9 is a perspective view of the corner;

FIG. 10 is a side view of the corner; and,

FIG. 11 is an exploded view of corner tarp connector system of the present invention.

### DETAILED DESCRIPTION OF THE PREFERRED EMBODIMENTS

A presently preferred embodiment of the inventive system presented herein consists of a system for securing tarps based on frames created by a combination of tarp connectors and corner tarp connectors system.

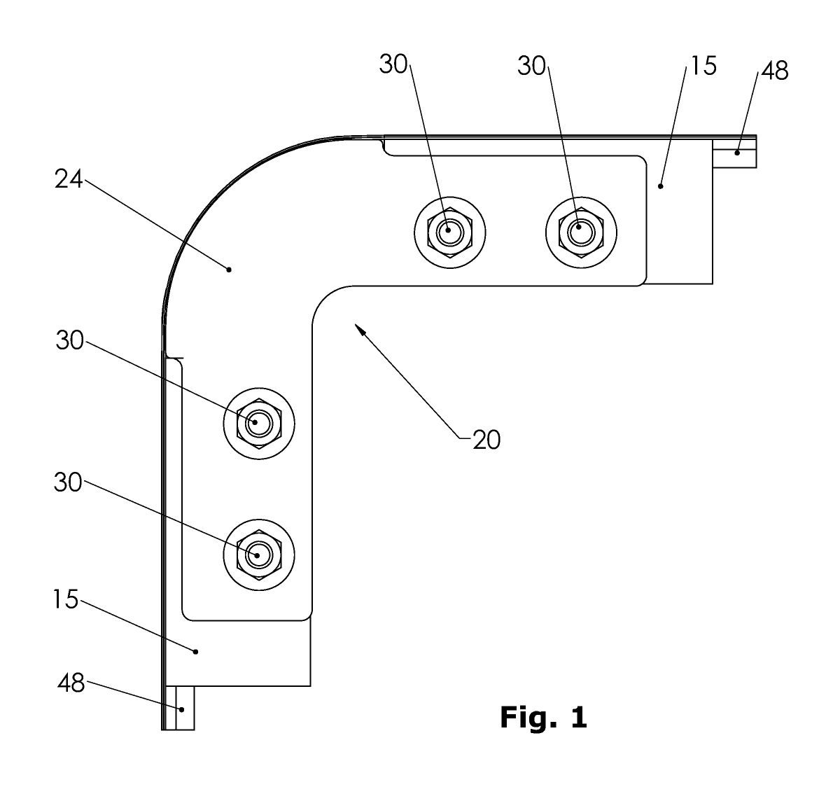

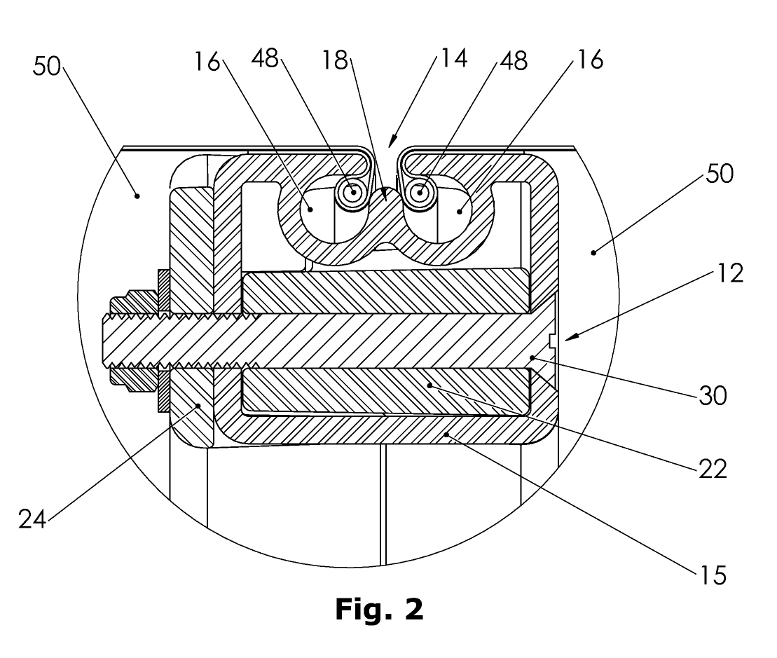

The corner tarp connector system 20 is shown in FIGS. 1 and in a section cut in FIG. 2. The tarp connector 15 comprises a frame creating an enclosure. A tarp support element 18 is formed in the frame on the inside of the enclosure and provides a pair of channels 16. A gap 14 in the frame allows the tarps 50 to enter and exit the channels 16.

In use, an end or section of the tarp 50 is wrapped around a tube 48, preferably made of plastic, and the tube into the pole channel 16. The gap 14 is dimensioned such that the tarp 50 is welded together and wrapped around to tube 48, cannot pass through the gap 14. The use of the tubes 48 eliminates the need for modifications to the tarp 50 to secure the tarp 50 to the tarp connector 15.

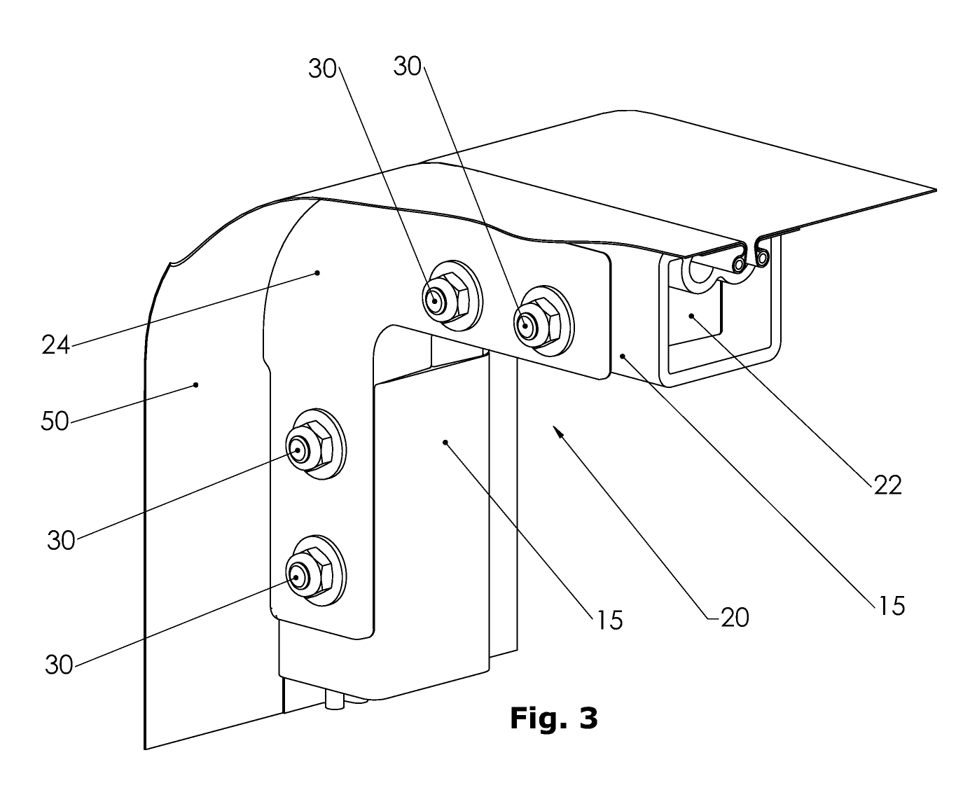

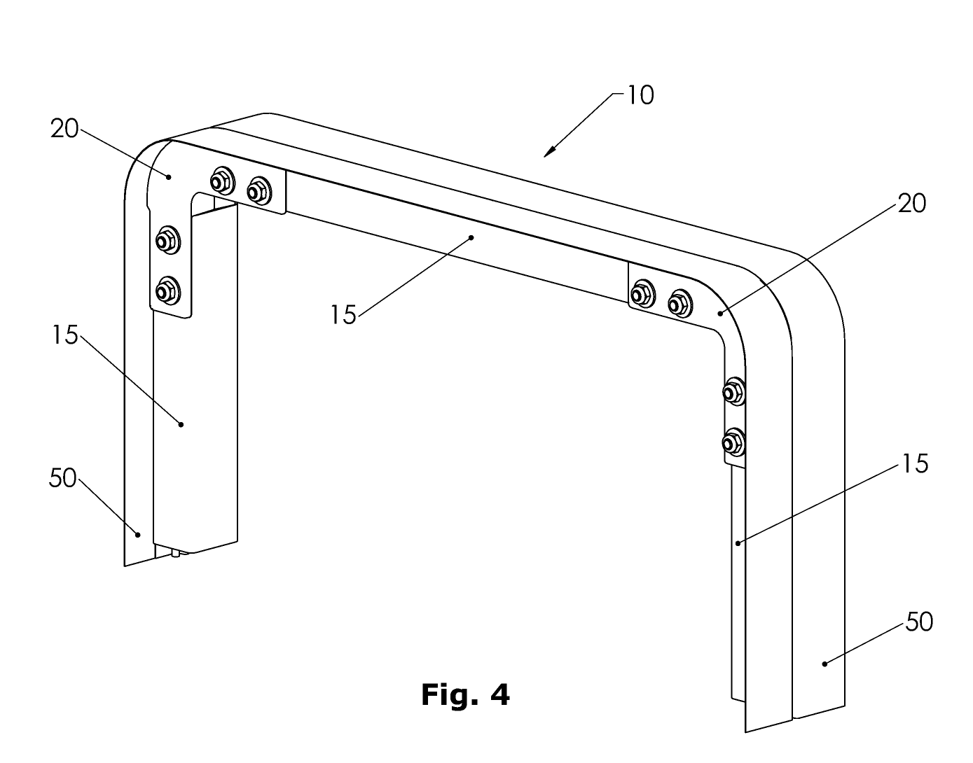

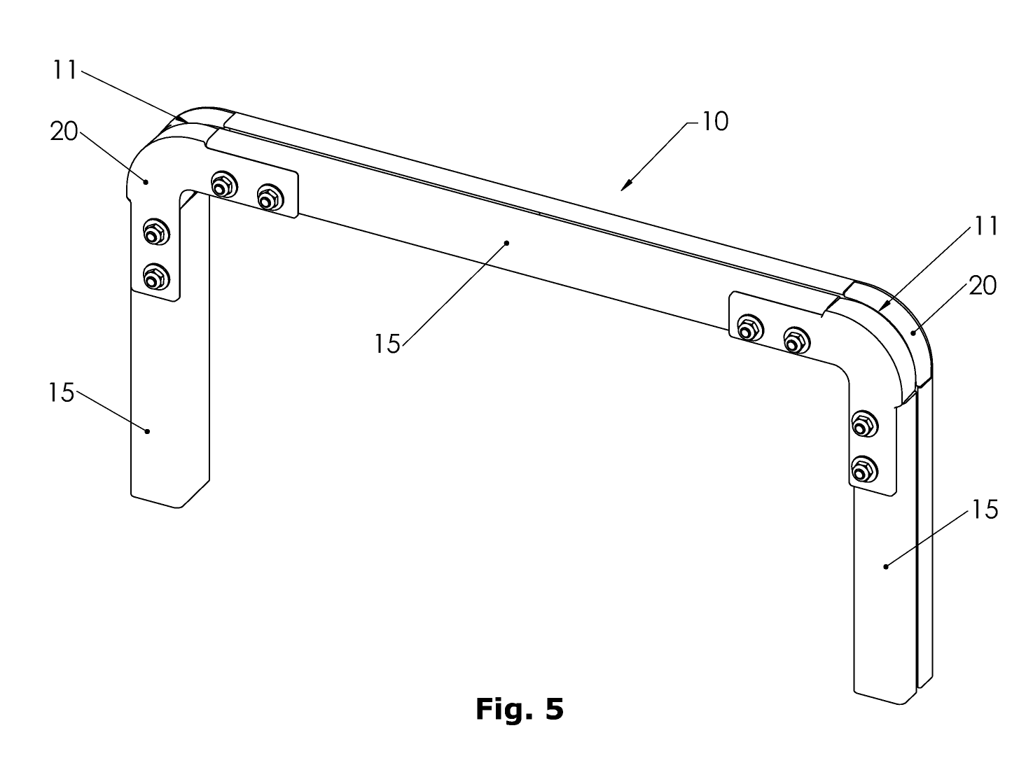

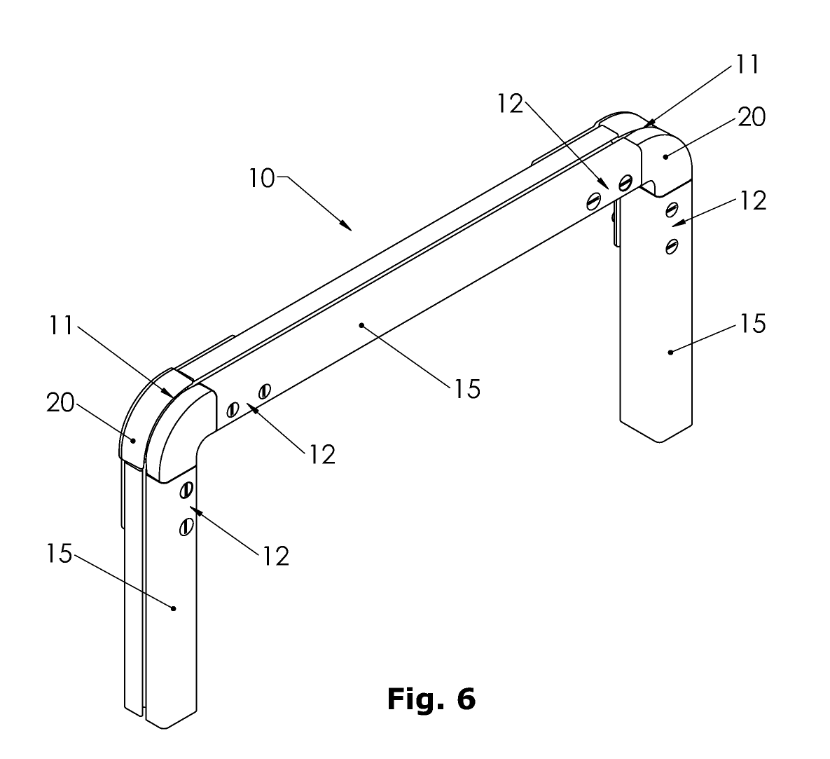

At the corners, the tarp connector 15 is coupled to the corner tarp connector system 20 as shown in FIG. 3, FIG. 4, FIG. 5 and FIG. 6 to create a frame 10 to support the tarps and create and enclosed cargo area.

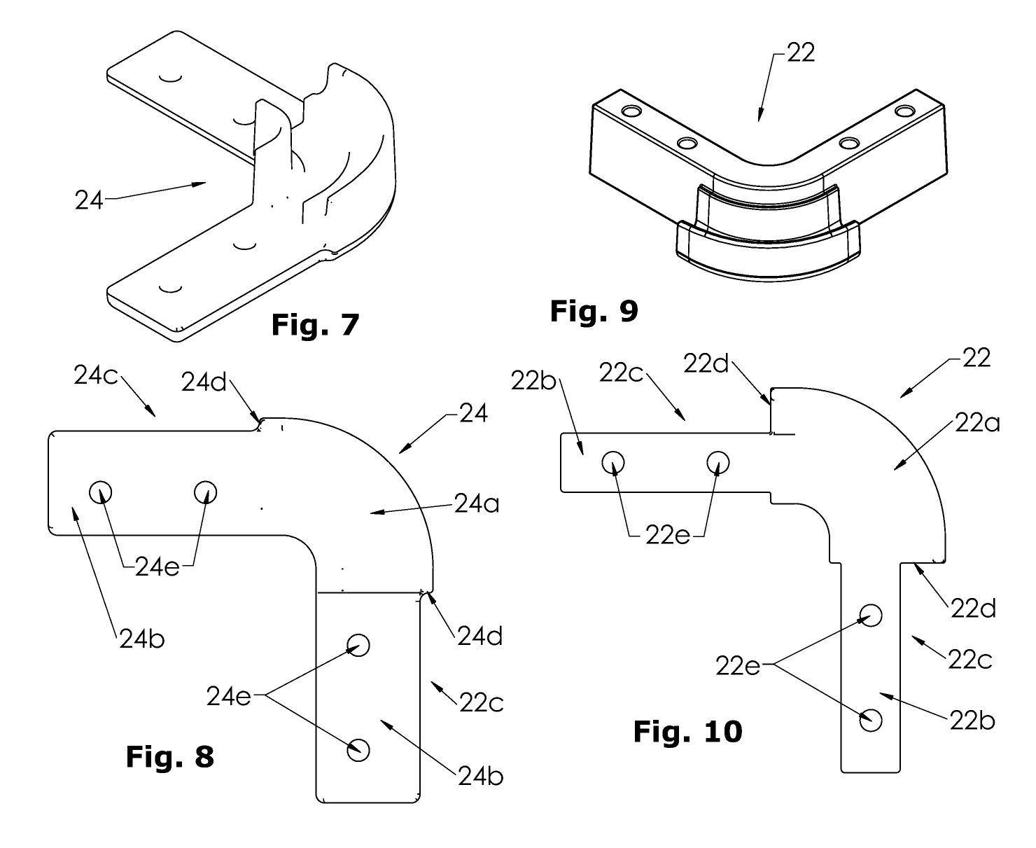

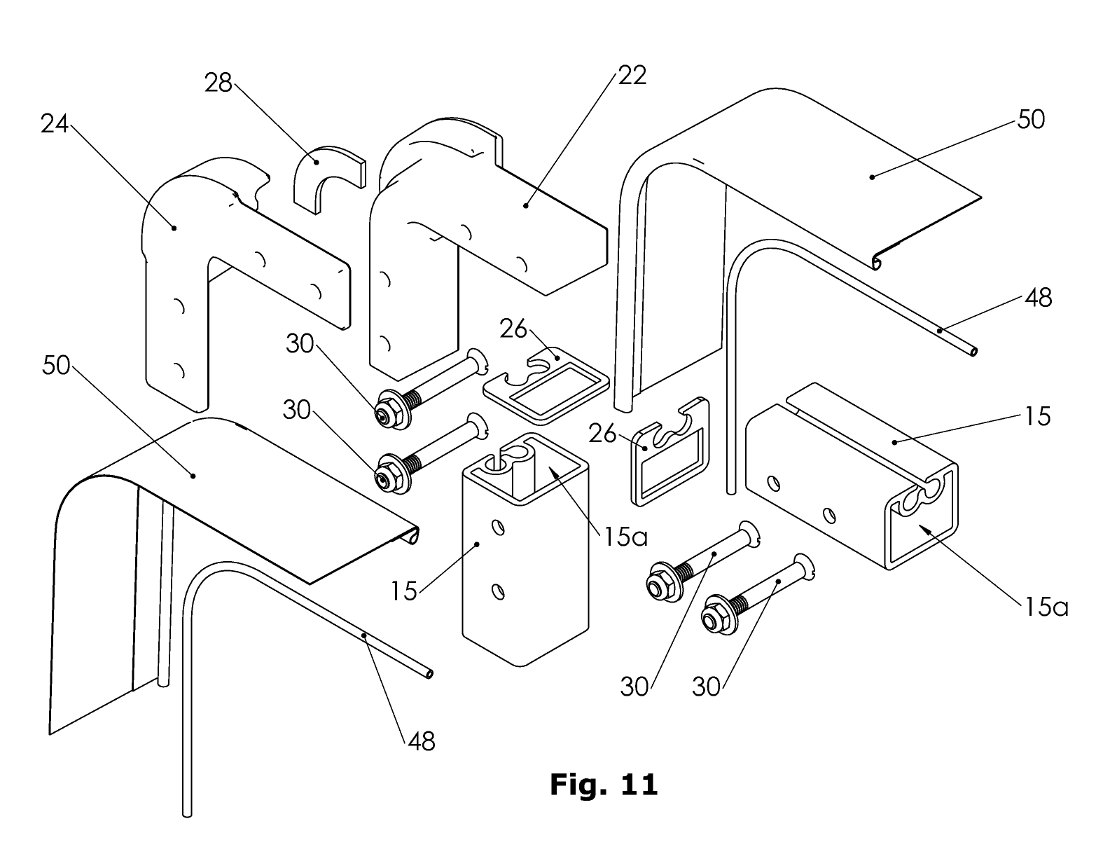

The corner connector system 20 is mainly formed from two pieces, the corner cap 24, as shown in FIG. 7, FIG. 8, and FIG. 11 and corner 22, as shown in FIG. 9 and FIG. 10 and FIG. 11. A tarp connector gasket 26, and side corner gasket 28 in compressed condition, is used to provide a sealed area at the corner tarp connector system, as shown in FIG. 11. The Corner cap 24 is mounted as last component in the corner tarp connector system 20 to ease sliding of the tarp 50 in the corners while being assembled. The corner 22 has a main body 22a providing the strength of the structure and faces 22d providing enclosure between tarp connectors. The corner 22 having a main body 22a has two step portions 22b extended in both sides at the opposite direction. The step portions 22b, while inserted into the tarp connectors within the inside tarp connector profiles 15a, provides a capture of the corner tarp connector system 20 and tarp connectors 15, step space 22c allows the assembling of the corner 22 and tarp connectors 15 . The corner cap 24 has a main body 24a extended outward forming an enclosure with the corner , the extended steps 24b in opposite direction are added to the main body 24a providing a closure between the corner tarp connector system 20 and the tarp connector 15 of the frame 10. The step space 24c is dimensioned such a way that the tarp 50 while tensioned does not have any constant with the extended step 24b. In the preferred embodiment shown, one or more holes 22e and 24e respectively in the corner 22 and corner cap 24, is provided for use in securing the tarp connectors 15 to corner tarp connector system 20, preferably using a nut-and-bolt combination 30.

When closed the corner tarp connector system 20 has a gap 11 dimensioned such a way that the gap does not allow the tarp 50 and tube 48 to come out, providing a securement of the tarp at the corners. The holes of face 12 of the tarp connectors are countersunk to accept the head of the fastener and sit either flat or under it, allowing the face 12 to be sealed against a seal element when required.

The resulting frames 10 provide a maximum amount of interior space and a minimum amount of external space. The frames 10 are particularly useful for cargo shipment, such as lumber, which require no obstructions inside the cargo space to allow for optimal loading of cargo and maximum usage of space. The minimum space amount externally allows, at the same time, a maximum possible internal space internally and is consistent with the width limitations imposed from ministry of transportation.

This concludes a description of a presently preferred embodiment of the invention. The forgoing description as has been presented for the purpose of the illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A system for connecting tarps to a vehicle, comprising:
a) Frames for supporting tarps, the frames comprised of:
i) One or more tarp connectors, each of the tarp connectors having a pair of channels for accepting a support pole, and
ii) One or more corner connector systems adapted to couple with an end of one of the tarp connectors and having channels to accept and retain the trap;
b) a plurality of tarps, each tarp secured to the tarp connectors by securing the tarp around the support pole and inserting the support pole into the channel of the tarp connector,
wherein the frames are combined with the tarps to create an enclosed cargo area for the vehicle.

2. The system of claim 1, wherein the tarp connectors are detachably removable from the corner connector systems.

3. The system of claim 1-2, wherein the end of the tarp connector fits within an end of the corner connector system.

4. The system of claim 1-3, wherein an end of the corner connector system fits within the end of the tarp connector.

5. The system of claim 1-4, wherein the tarp connectors are detachably removable from the corner connector system.

6. The system of claim 1-5, wherein the end of the tarp connector fits within an end of the corner connector system

7. The system of claim 1-6, wherein an end of the corner connector system fits within the end of the tarp connector

8. The system of claim 1-7, wherein the tarps are secured to the support poles by welding.

9. A method of connecting tarps to a vehicle, comprising:
a) attaching frames to a vehicle, the frames comprised of:
i) one or more tarp connectors, each of the tarp connectors having a pair of channels for accepting a support pole and;
ii) one or more corner connector systems adapted to receive an end of one of the tarp connectors;
b) securing the tarps around the support poles, and
c) inserting the support poles with the secured tarps into the tarp connectors and corner tarp connector system to create a cargo area for the vehicle enclosed by the tarps.

10. The method of claim 9, wherein said tarp connectors are detachably removable from the corner connector systems.

11. The method of claim 10, wherein the tarps are secured to the support poles by welding or sewing.

12. A corner tarp connector system for a system for connecting the tarps, mainly comprising two separate pieces, a corner and corner cap, which combine to form the corner connector system, each piece having a slot such that when connected, the slots combine to form a slot for retaining the tarps and tubes by securing them at corner connections.

13. A corner connector system of claim 12 comprising:
a) a corner comprising:
i) a main body with opposite directed faces ;
ii) one or more extensions or step portions, part of the main body;
iii) each extensions or step portion has one or more holes to accept the fasteners connecting the corner system with tarp connectors;
iv) an extended shape outward and around the main body producing closure at the corner for the tarp connectors.
b) a corner cap comprising:
i) a main body with outward step extensions, providing support for tarps ;
ii) one or more steps of the main body extended outside of the tarp connectors adapted for retaining the tarp at corners;
iii) each step portion has one or more holes to accept the fasteners connecting the corner system with tarp connectors;
iv) an extended shape outward and around the main body producing closure for the tarp connectors.

14. The system of claim 12-13, wherein one or more compressible gaskets are adapted to fit within the profile of the said tarp connectors and the said corner system as a sealing element.

15. The system of claim 12, wherein one or more compressible gaskets adapted to seal the said corner and the said corner cap.

16. The corner tarp connector system of claim 1-15, wherein the tarp connector further comprises an attachment mechanism, the attachment mechanism enabling the corner tarp connector system to be attached to tarp connector.

17. The tarp connector of claim 16, wherein the attachment mechanism comprises a washer, nut and bolt.
